(19) United States
(12) Patent Application Publication
(10) Pub. No.: US 2025/0382743 A1
(43) Pub. Date: Dec. 18, 2025

(54) ARTIFICIAL LEATHER WITH COOL SURFACE FEATURE

(71) Applicant: DOW GLOBAL TECHNOLOGIES LLC, Midland, MI (US)

(72) Inventors: Nan WANG, Shanghai (CN); Yanli FENG, Shanghai (CN); Tengfei LIU, Shanghai (CN); Xiaolin HUANG, Shanghai (CN)

(21) Appl. No.: 19/141,288

(22) PCT Filed: Dec. 20, 2022
(86) PCT No.: PCT/CN2022/140390

§ 371 Date: Jun. 19, 2025

(51) Int. Cl. D06N 3/14; B32B 5/02; B32B 5/18; B32B 5/24; B32B 27/06; B32B 27/12; B32B 27/18; B32B 27/30; B32B 27/40; C09K 5/06; D06N 3/00; D06N 3/04; D06N 3/18

(52) U.S. Cl. CPC D06N 3/145; B32B 5/02; B32B 5/18; B32B 5/245; B32B 27/065; B32B 27/12; B32B 27/18; B32B 27/308; B32B 27/40; C09K 5/063; D06N 3/0004; D06N 3/0043; D06N 3/0061; D06N 3/0077; D06N 3/0097; D06N 3/042; D06N 3/183; B32B 2260/021; B32B 2260/046; B32B 2262/12; B32B 2264/0292; B32B 2266/0278; B32B 2270/00; B32B 2274/00; D06N 2205/02; D06N 2209/06; D06N 2209/10

(57) ABSTRACT

Artificial leathers have a top layer that contains a solid, water-insoluble polyurethane elastomer, a solid, water-insoluble acrylate elastomer, and embedded particles of an encapsulated phase change material. The top layer imparts a desirable “cool touch” feature to the artificial leather, while also imparting other important physical and tactile properties such as a soft and smooth feel. An artificial leather comprises a backing layer and a top layer bonded directly or indirectly to the backing layer. The top layer comprises, by total weight of the top layer: (i) 25 to 75 weight percent of a solid, water-insoluble polyurethane elastomer; (ii) 10 to 40 weight percent of a solid, water-insoluble acrylate elastomer; and (iii) 1.5 to 30 weight percent of embedded particles of an encapsulated phase change material. The encapsulated phase change material (iii) has a melting or glass transition temperature of 20 to 37° C.

This invention relates to artificial leathers and methods for making them.

Artificial leathers are widely used as a less-expensive substitute for natural leather. Recent advancements in artificial leather technology has led to products that closely resemble the look, feel and performance of natural leather. Artificial leather is widely used in garments, furniture and automotive applications such as seat upholstery and interior trim.

These artificial leather products typically are multi-layer assemblies having one or more polymer coatings on a fiber substrate. The polymer coatings are often based on aqueous polyurethane dispersions, which are used to produce the top (or “show”) surface of the artificial leather product and, in some cases, intermediate layers such as one or more foam layers. Aqueous polyurethane dispersions have environmental and handling advantages over previous-generation, solvent-based polyurethane dispersions used in this application area. Issues of odor, exposure to solvents and other environmental and occupational safety issues are largely avoided through the use of aqueous polyurethane dispersions.

Artificial leathers tend to be excellent at retaining heat. This makes artificial leather a valuable material of construction for winter clothing, shoes and even furniture and automotive seating, where the feeling of warmth obtained when the artificial leather retains heat is desirable.

There are applications in which this heat retention ability is less desirable. An example of this is baby mats. Artificial leather baby mats can become uncomfortably warm for small children, particularly in summer months. Similarly, applications like automotive seating and furniture sometimes would benefit if the artificial leather had less heat retention ability.

This invention is in one aspect an artificial leather comprising a backing layer and a top layer bonded directly or indirectly to the backing layer, the top layer comprising, by total weight of the top layer, (i) 25 to 75 weight percent of a solid, water-insoluble polyurethane elastomer, (ii) 10 to 40 weight percent of a solid, water-insoluble acrylate elastomer and (iii) 5 to 30 weight percent of embedded particles of an encapsulated phase change material that has a melting or glass transition temperature of 20 to 37° C.

This artificial leather has a reduced heat retention ability, compared to previous artificial leather products, yet retains physical and tactile properties that are wanted in artificial leather products. The artificial leather exhibits excellent surface smoothness, is soft to the touch, resists damage from abrasion and repeated flexing.

The invention in another aspect is an aqueous dispersion comprising a continuous aqueous phase, the continuous aqueous phase having dispersed therein, by total weight of the aqueous dispersion, (i) 15 to 40 weight percent of internally stabilized solid particles of a water-insoluble polyurethane elastomer, (ii) 5 to 20 weight percent of particles of a water-insoluble acrylate elastomer and (iii) 3 to 15 weight percent of particles of an encapsulated phase change material that has a melting or glass transition temperature of 20 to 37° C., (i), (ii) and (iii) together constituting 35 to 65% of the total weight of the aqueous dispersion.

This dispersion cures to form an elastomeric material useful as the top layer of the artificial leather of the invention. The cured material exhibits a desirable soft, “cool touch” feel, and is highly elastomeric with a low modulus.

The artificial leather of the invention includes a backing layer, a top layer, and optionally one or more intermediate layers.

The backing layer is not particularly limited and may be or include, for example, a fabric, a metal film, a plastic film, an elastomeric sheet or film, or a natural leather (such as split leather). The backing layer preferably is a flexible material in the form of a sheet or film having a thickness of 0.01 to 10 mm, especially 0.1 to 5 mm.

Fabrics are especially preferred backing layers. The fabrics comprise fibers that may be, for example, woven, knitted, braided, non-woven, melt-bonded, spun-bonded, needle-punched and/or entangled. The fibers may be of a natural material such as wool, cotton, linen, hemp and the like, and/or may be synthetic fibers such as polyester, polyamide, polyolefin, poly(vinyl chloride), acrylic, poly(vinyl alcohol) and the like. Fibers blends are useful.

A backing layer material of particular interest comprises microfibers coated with or embedded in an elastomeric polymer. Such a fabric is conveniently made according to methods as described in WO 2018/045546A1. As described there, a fabric is made using an “islands-in-the-sea” type multicomponent fiber. The fiber comprises a bundle of separate filaments made of materials that differ in their solubility characteristics, so that filaments of one type can be selectively dissolved and removed without dissolving filaments of another material. Polyolefin/polyamide islands-in-the-sea fibers are an example of a suitable type. The fabric is embedded and/or coated with an elastomeric polymer. The elastomeric polymeric is characterized in having, as a bulk material, a glass transition temperature by differential scanning calorimetry of −10° C. or lower and an elongation to break of at least 50%, especially at least 100% or at least 200% as measured according to GB/T 528-2009. The embedding or coating step can be performed, for example, by impregnating the fabric with a dispersion of the elastomeric polymer and/or a reaction mixture containing precursors that cure to produce the elastomeric polymer, and then curing the impregnated fabric to produce the elastomeric polymer. The elastomeric polymer may be a polyurethane or an acrylate polymer, for example. In a particular embodiment, the fabric is embedded and/or coated by impregnating it with an aqueous polyurethane dispersion. The aqueous polyurethane dispersion may be heat-coagulable, such as by comprising both a cationic external surfactant and an anionic external surfactant as described in WO 2018/045546A1. The embedded and/or coated fabric is then contacted with a solvent for some but not all of the filaments of the multicomponent fiber to preferentially dissolve and remove the soluble filaments, leaving the insoluble filaments behind.

The top layer comprises, by total weight of the top layer, (i) 25 to 75 weight percent of a solid, water-insoluble polyurethane elastomer, (ii) 10 to 40 weight percent of a solid, water-insoluble acrylate elastomer and (iii) 5 to 30 weight percent of embedded particles of an encapsulated phase change material that has a melting or glass transition temperature of 20 to 37° C. Component (i) in some embodiments constitutes a least 30% or at least 35% of the total weight of the top layer, and in some embodiments may constitute up to 70% of the total weight of the top layer. Component (ii) in some embodiments constitutes at least 12% of the total weight of the top layer, and in some embodiments may constitute up to 35% thereof.

Components (i)-(iii) preferably together constitute at least 85%, preferably at least 90%, of the total weight of the top layer. The remaining portion of the weight of the top layer comprises various optional, non-volatile ingredients as may be present in an aqueous dispersion used to produce the top layer, as described more fully below. The total weight of the top layer is generally equal to the weight of the solids of the polyurethane dispersion used to make the top layer and can be calculated as the weight of the dispersion times the solids content. The solids include all non-volatile materials that are not removed during the curing step.

The top layer preferably is produced by forming a film of an aqueous dispersion and curing the film to form. The aqueous dispersion comprises a continuous aqueous phase having dispersed therein, by total weight of the aqueous dispersion, (i) 15 to 40, preferably 18 to 35, weight percent of internally stabilized solid particles of the water-insoluble polyurethane elastomer, (ii) 5 to 20, preferably 7 to 18, weight percent of particles of the water-insoluble acrylate elastomer and (iii) 3 to 15, preferably 5 to 15, weight percent of particles of an encapsulated phase change material that has a melting or glass transition temperature of 20 to 37° C., (i), (ii) and (iii) together constituting 35 to 65% of the total weight of the aqueous dispersion.

“Curing” is used herein to simply mean that the coating composition is formed into a solid coating by any mechanism or combination of mechanisms as appropriate for the particular elastomeric polymer that is present. It is not necessary that any chemical reaction (such as, for example, polymerization, crosslinking or chain extension) take place during the curing step, although such a reaction may take place in some cases. In preferred embodiments, curing is performed by drying the film at approximately room temperature (20-25° C.) or at an elevated temperature of, for example, at least 40° C. or at least 60° C. and, for example, up to 160° C. or up to 140° C.

The solid, water-insoluble polyurethane elastomer preferably, by itself, exhibits an elongation to break of at least 50%, at least 100%, at least 250% or at least 500%, as measured according to GB/T 528-2009. It preferably by itself exhibits a glass transition temperature by differential scanning calorimetry of −10° C. or lower, especially −40° C. or lower.

The solid, water-insoluble polyurethane elastomer in some embodiments is made by forming an isocyanate-terminated prepolymer, dispersing the prepolymer into water, and chain-extending the prepolymer with water and/or other chain extender to form polyurethane particles dispersed in an aqueous phase. The prepolymer preferably is internally stabilized, meaning that the prepolymer contains covalently bonded hydrophilic groups such as ionic groups and poly (oxyethylene groups) that upon chain extension emulsify the polyurethane particles in the aqueous phase.

The prepolymer preferably is a reaction product of at least one polyether polyol having a hydroxyl equivalent weight of 400 to 8,000 g/equivalent, preferably 500 to 2,200 g/equivalent, at least one hydroxyl-, primary amine- or secondary amine-containing compounds having hydrophilic groups or precursors to hydrophilic groups, and an excess of at least one polyisocyanate. Equivalent weight is determined by measuring a hydroxyl number using a titration method such as ASTM D4274-21 and converting the hydroxyl number (in mg KOH/g) to equivalent using the relationship equivalent weight=56,100÷hydroxyl number.

The polyether polyol used to make the prepolymer is preferably insoluble in water at 25° C. and may be, for example, a homopolymer of 1,2-propylene oxide, 1,2-butylene oxide, 2,3-butylene oxide, tetrahydrofuran, a copolymer (block and/or random) of any two or more thereof, and/or a copolymer (block and/or random) of any one or more of these and up to, for example, 20 weight percent ethylene oxide. The polyether polyol nominally may have, for example, 2 to 8, 2 to 6, 2 to 4 or 2 to 3 hydroxyl groups per molecule.

The hydroxyl-, primary amine- or secondary amine-containing compounds having hydrophilic groups or precursors to hydrophilic groups in some embodiments contain one or more hydroxyl groups and one or more anionic groups such as carboxylate, sulfonate and phosphate groups in the form of their alkali metal or ammonium salts. It may contain carboxyl, carboxylic acid anhydride, sulfonic acid and/or phosphoric acid groups that can be converted to the corresponding carboxylate, sulfonate and phosphate groups by neutralization with an appropriate base and/or hydrolysis followed by neutralization. Specific examples include dihydroxymethyl propionic acid, dimethylol butanoic acid, dihydroxysulfonic acids, dihydroxyphosphonic acids such as 2,3-dihydroxylpropanephosphonic acid and the like.

In other embodiments, the one hydroxyl-, primary amine- or secondary amine-containing compounds having hydrophilic groups contain one or more hydroxyl and/or primary or secondary amino groups and one or more cationic groups such as protonated tertiary amino groups or quaternary amino groups (in the form of their phosphate, sulfate, carboxylate, halide, salts, for example), and/or precursors to such groups which can be neutralized to form the corresponding cationic groups. Specific examples include tris(hydroxyalkyl)amines, N,N′-bis(hydroxyalkyl)alkyl amines, N-hydroxyalkyldialkylamines, tris(aminoalkyl)amines, N,N′-bis(aminoalkyl)alkyl amines, N-aminoalkydialkylamines and the like. These are tertiary amine compounds that can be converted to ammonium salts by reaction with acids such as phosphoric acid, sulfuric acid, halohalic acids such as HCl or HBr, or by reaction with suitable quaternizing agents such as C₁₋₆ alkyl halides or benzyl halides.

A third type of hydroxyl-, primary amine- or secondary amine-containing compounds having hydrophilic groups is a homopolymer of ethylene oxide or a copolymer of ethylene oxide having a poly(oxyethylene) block of at least 15, preferably at least 20 oxyethylene units, and one or more hydroxyl groups.

The polyisocyanate used to make the prepolymer has an average of at least 2 isocyanate groups per molecule. The isocyanate groups may be covalently bound to aromatic, aliphatic and/or alicyclic carbon atoms. Examples of useful polyisocyanates include diphenylmethane diisocyanate (any isomer or mixture of isomers), p-phenylene diamine, toluene diisocyanate (any isomer or mixture of isomers), polymethylene polyphenylene polyisocyanates having 3 or more phenyl isocyanate groups, so-called “polymeric MDI” which is a mixture of diphenyl methane diisocyanate and higher polymethylene polyphenylene polyisocyanates, 1,5-naphthalene diisocyanate, hydrogenated MDI (“H₁₂-MDI”), 1,3-bis(isocyanatomethyl)cyclohexane, 1,4-diisocyanatocyclohexane, isophorone diisocyanate, hexamethylene diisocyanate, and the like.

The prepolymer can be made by reacting the various precursors neat or in a suitable solvent. The precursors can be combined or reacted all at once, or in various sequences. The prepolymer is then dispersed as droplets in water where it reacts with water or other chain extender to produce solid, water-insoluble polyurethane elastomer particles. Suitable chain extenders (besides water), include compounds having formula molecular weights of up to 250, preferably up to 150, that have two or more, preferably exactly two, hydroxyl, primary amino and/or secondary amino groups per molecule. Examples include piperazine, an amine-terminated polyether, aminoethylethanolamine, monoethanolamine, and ethylene diamine.

The resulting polyurethane dispersion may have a solids content of, for example, 20 to 70% by weight, preferably 25 to 60% by weight or 40 to 60% by weight. The D50 particle size of the dispersed polyurethane particles may be, for example, at least 20 nm or at least 50 nm and up to 2,000 nm or up to 1,000 nm, as measured by laser diffraction.

In some embodiments, the polyurethane dispersion contains no external surfactant, i.e., no surfactant that is not covalently bonded to the polyurethane particles.

Suitable polyurethane dispersions are commercially available from The Dow Chemical Company under the Syntegra™ trade name, including, for example Syntegra™ YS 3076 dispersion, as is described more fully in the examples section, and Syntegra™ YF 4000 Dispersion by The Dow Chemical Company. The latter product has a solids content is about 54% by weight; cured films made by coagulating this dispersion by itself have a 100% modulus of approximately 2.5 MPa and an elongation of 600-800%.

The water-insoluble acrylate elastomer is a polymer of one or more acrylate monomers such as methyl acrylate, ethyl acrylate, hydroxyethyl acrylate, t-butyl acrylate, n-butyl acrylate, hexyl acrylate, 2-ethylhexyl acylate and the like. Various comonomers may be copolymerize with the acrylate monomer(s) if desired, in block, random and/or graft fashion, to produce the acrylate elastomer. The acrylate elastomer by itself preferably exhibits an elongation to break of at least 50%, at least 100%, at least 250%, and preferably has a glass transition temperature as measured by differential scanning calorimetry of −10° C. or lower, preferably −25° C. or lower or −40° C. or lower.

The water-insoluble acrylate elastomer preferably is provided in the form of an aqueous dispersion. The acrylate elastomer may be produced as an emulsion or dispersion in a liquid phase that includes water and/or one or more other compounds that are liquid at room temperature (23° C.) and have a boiling temperature at standard pressure of 40 to 100° C. Such an emulsion may be produced in a emulsion polymerization process, in which one or more monomers are dissolved or dispersed into a liquid phase and subjected to polymerization conditions until the polymer chains precipitate and are converted to polymer particles or droplets dispersed in the liquid phase.

Similarly, an emulsion or dispersion of the acrylate elastomer can be produced in a mechanical dispersion process in which molten acrylate elastomer is dispersed into such a liquid phase. The liquid phase used in such a mechanical dispersion process can form some or all of the liquid phase of the emulsion or dispersion used to coat the polyurethane foam in accordance with this invention.

In yet another suitable process, the acrylate elastomer may be ground or otherwise formed into small particles that are then dispersed in a liquid phase to form the emulsion or dispersion.

The particle size of the acrylate elastomer particles preferably is as generally described with regard to the dispersed polyurethane elastomer particles.

Suitable dispersions of acrylate elastomers are commercially available from The Dow Chemical Company under the Rhoplex™ trade name, such as Rhoplex™ 3166 dispersion.

A dispersion of acrylate elastomer particles, produced in any of the foregoing methods, preferably contains at least one external surfactant to stabilize the dispersion against settling. Cationic, nonionic, zwitterionic and/or anionic surfactants all are suitable.

The encapsulated phase change material (iii) includes a phase change material that has a melting or glass transition temperature of 20 to 37° C., which phase change material is contained within a shell. The phase change material preferably has a melting temperature of 20 to 37° C. and more preferably has a melting temperature of 25 to 32° C. or 28 to 32° C. The encapsulated phase change material may exhibit a heat of fusion within the temperature range of 20 to 37° C. of at least 50 Joule/gram (J/g), at least 100 J/g or at least 150 J/g, as measured by differential scanning calorimetry. The heat of fusion may be as much as 300 J/g or more, but is more commonly up to 250 J/g or up to 200 J/g.

For purposes of this invention, the weight of the phase change material includes the weight of the shell. The shell may constitute, for example, 5 to 25% of the total weight of the encapsulated phase change material, the phase change material itself constituting the remainder thereof, i.e., 75 to 95% by weight thereof.

The phase change material may be or contain, for example, a wax or mixture of waxes. The wax may be one or more of a natural or synthetic wax such as a polyethylene wax, bees wax, lanolin, carnauba wax, candelilla wax, ouricury wax, sugarcane wax, jojoba wax, epicuticular wax, coconut wax, petroleum wax or paraffin wax, provided that foregoing waxes that individually have melting temperatures below 20° C. or above 37° C. are used as a blend or mixture with one or more waxes such that the combination exhibits a melting temperature in the range of 20 to 37° C.

The phase change material in some embodiments is an alkane having 14 to 30, especially 14 to 24 or 16 to 22 carbon atoms or a mixture of any two or more thereof. In a specific embodiment, the phase change material includes octadecane and/or eicosane.

The shell material may be, for example, a polymeric material that has a melting or decomposition temperature of at least 50° C. and preferably at least 100° C. Examples of useful shell materials include crosslinked thermoset resins such as crosslinked melamine-formaldehyde, crosslinked melamine, crosslinked resorcinol urea formaldehyde and gelatin.

The encapsulated phase change material is in the form of particles. The particles may have particle sizes of 100 nm to 100 μm as measured by microscopy. In some embodiments, the particles have particle sizes of at least 250 nm, at least 500 nm, at least 1 μm or at least 5 μm, and up to 75 μm or up to 50 μm.

Suitable methods for preparing the encapsulated phase change material are described, for example, in U.S. Pat. Nos. 10,221,323 and 10,005,059.

Suitable encapsulated phase change materials are available from Microtek Laboratories, Dayton, Ohio, US.

The aqueous dispersion of the polyurethane elastomer, the aqueous dispersion of the acrylic elastomer and encapsulated phase change material are combined in any order to produce a coating composition which is then formed into the top layer. In some embodiments, the encapsulated phase change material is combined with an aqueous dispersion of the acrylic elastomer, which is then combined with the dispersion of the polyurethane elastomer. A commercially available aqueous dispersion of an acylate elastomer that also contains dispersed encapsulated phase change material is available from the Dow Chemical Company under the Aquachill™ trade name, including Aquachill™ HT705, Aquachill™ HT706 and Aquachill™ HT710 dispersions.

The coating composition may include one or more optional materials, in addition to those already described. Those which are not volatile typically become incorporated into the top layer when the coating composition is formed into a film and cured.

Another useful optional material is one or more external surfactants, which may be brought in with the polyurethane elastomer dispersion, the acrylate elastomer dispersion and/or as a separate ingredient, and which can perform one or more useful functions. Such a surfactant may function as a stabilizing agent for the acrylate elastomer particles and/or, less preferably, for the polyurethane elastomer particles. A surfactant may function as a wetting agent, facilitating the dispersion of the particles of the phase change material into the remaining ingredients of the coating composition. A surfactant may function as a defoamer or deaerator, to reduce the entrainment of gases by the coating composition and reduce bubbles. Various silicone surfactants are useful for these purposes, as well as various non-silicone surfactants such as sulfate esters, sulfonate esters, phosphate esters, ethoxylates, fatty acid esters, amine oxides, sulfoxides and phosphine oxides. A surfactant may be nonionic, anionic, cationic or zwitterionic. One or more surfactants may constitute, for example, 0.1 to 5 weight-percent based on the total weight of the coating composition. Any such surfactant is considered as part of the solids content of the coating composition for purposes of this invention.

Other useful ingredients include various rheology modifiers such as various thickeners and thixotropic agents. Among these are fumed silica and various water-soluble or water-swellable polymers of acrylic acid that contain free acid groups or carboxylic acid salt groups (such as, for example, alkali metal, ammonium (NH₄), quaternary ammonium, or quaternary phosphonium carboxylic acid salts). Particularly useful rheology modifiers include aqueous emulsions of crosslinked acrylic acid polymers, such as are sold by DuPont under the trade designation Acrysol®. Specific examples are Acrysol® ASE-60 and Acrysol ASE-95. When present, such rheology modifiers may constitute, for example, 0.01 to 5 weight-percent, preferably 0.05 to 1 weight percent, of the coating composition. Any such rheology modifier is considered as part of the solids of the coating composition for purposes of this invention.

The coating composition may contain one or more other compounds (in addition to water) that are liquid at room temperature (23° C.) and have boiling temperatures at standard pressure of 40 to 100° C. Such compounds, if present at all, preferably constitute no more than 5% by weight, especially no more than 2% of the total weight of the coating composition. As such compounds are generally removed during the curing step, they do not form part of the top layer upon curing and such compounds are not counted as part of the solids content of the coating composition.

The coating composition may contain one or more crosslinkers. Crosslinkers are compounds having two or more functional groups that react under the conditions of the curing step with functional groups on the polyurethane elastomer and/or acrylate elastomer to form covalent bonds thereto. Examples of crosslinkers include aziridines; diols such as propylene glycol, ethylene glycol, dipropylene glycol, tripropylene glycol, diethylene glycol, diethanolamine and diisopropanolamine; diamines such as ethylene diamine, diethylene triamine, monoethanolamine, and the like.

Other ingredients of the coating composition may include, for example, colorants, preservatives, leveling agents, antioxidants and biocides, all of which are considered as part of the solids of the coating composition.

The top layer is produced from the coating composition by forming the composition into a film, gauging the film to predetermined thickness and curing the film to produce a solid elastomer. A film of the coating composition in some embodiments is cast onto a release sheet, such as release paper, gauged to the desired thickness in any convenient manner, and then cured. As described before, curing preferably includes or consists of one or more drying steps in which water and other volatile components of the coating composition are removed. The polyurethane elastomer particles and acrylate particles coagulate as part of the curing process to produce a solid, elastomeric top layer. The top layer subsequently is separated from the release sheet.

The resulting top layer may have a thickness of, for example, at least 0.01 μm, at least 1 μm or at least 10 μm, up to 1,000 μm or up to 500 μm.

In other embodiments, the coating composition is formed into a film on the backing layer or some optional intermediate layer, gauged and cured to produce the top layer.

The artificial leather of the invention may contain one or more intermediate layers, disposed between the backing layer and the top layer. Among these are (1) an elastomeric foam layer and (2) a barrier layer, which also is preferably elastomeric. Either or both may be present, as well as additional layers as may be beneficial. In particular embodiments, the artificial leather comprises, from top to bottom, the top layer, a barrier layer bonded to the top layer; a foam layer bonded to the barrier layer; and the backing layer bonded to the foam layer. In other particular embodiments, the artificial leather comprises, from top to bottom, A) the top layer, B) a foam layer bonded to the top layer and C) the backing layer bonded to the foam layer. In still other embodiments, the artificial leather comprises, from top to bottom, A) the top layer, B) a barrier layer bonded to the top layer and C) the backing layer bonded to the barrier layer.

An elastomeric foam layer is a layer of a cellular elastomer. The elastomeric foam layer, when present, may have a thickness of, for example, at least 0.1 μm, at least 1 μm or at least 10 μm and up to 2,000 μm or up to 1,000 μm. A preferred type of elastomeric foam layer is a polyurethane foam layer. Such a polyurethane foam layer can be made by forming a film of a frothed polyurethane dispersion or of a two-part polyurethane foam system, gauging the film and curing the film to produce the foam layer. A polyurethane dispersion may be as generally described above and/or as generally described in WO 2020/097838, for example, and may be internally and/or externally stabilized. A two-part polyurethane foam system includes one or more polyisocyanates, one or more isocyanate-reactive materials that preferably include at least one polyether polyol having a hydroxyl equivalent weight of 400 to 4,000, at least one chemical and/or physical blowing agent (especially water), and optionally additional ingredients such as one or more chain extenders, catalysts, foam-stabilizing surfactants, fillers, and the like. Suitable two-part polyurethane foam systems include those described in WO 2020/097838.

The barrier layer, if present, is preferably an elastomeric polyurethane layer. It preferably is made by forming a film of a polyurethane elastomer dispersion, gauging the film and curing the film. The polyurethane elastomer dispersion preferably is an aqueous dispersion. The polyurethane elastomer particles in such a dispersion may be internally and/or externally stabilized. In a particular embodiment, the dispersion is externally stabilized only, preferably with a mixture of both a cationic surfactant and an anionic surfactant as described in WO 2020/097838. The dispersion may be heat-coagulable as described in WO 2020/097838.

A barrier layer, if present, may have a thickness of, for example, at least 0.01 μm, at least 1 μm or at least 10 μm, up to 1,000 μm or up to 500 μm.

The artificial leather may contain one or more additional layers, such as a protective film layer on the top layer, one or more water-repellent layers, one or more UV protective layers, and one or more tactile modification layers.

The artificial leather is useful in various applications such as footwear, garments, handbags, purses, furniture upholstery, automotive upholstery, belts, gloves and other clothing accessories, strapping, and the like. An application of particular interest is mats, particularly mats for babies or other small children, gym mats, and the like, where the “cool touch” characteristics of the top layer are beneficial. The artificial leather may be subjected to various post-processing steps as necessary or desirable to adapt it for specific applications. For example, the artificial leather may be subjected to one or more brushing, filling, milling or ironing steps. The artificial leather may be uniaxially or biaxially stretched, which may improve breathability.

The following examples are provided to illustrate the invention but are not intended to limit the scope thereof. All parts and percentages are by weight unless otherwise indicated.

Acrylic/PCM Emulsion is an acrylic latex polymer emulsion that contains about 32% by weight acrylic latex solids and about 23% by weight microencapsulated paraffin wax particles having a particle size of about 15-30 μm. The wax constitutes 85-90% of the weight of the microencapsulated paraffin wax particles, a polymeric shell constituting the remainder of the weight of the product. The phase change material has a melting of approximately 28° C. and an enthalpy of melting of 180-190 J/g. The latex particles are an elastomeric polymer having a T_{g} of less than −10° C. Product Brookfield viscosity is 1700-3000 mPa·s at 25° C. (S64 rotor, 1000 rpm).

The PU Emulsion is an aqueous dispersion of particles of an isophorone diisocyanate based polyurethane elastomer, sold as Syntegra™ YS-3076 Dispersion by The Dow Chemical Company. Solids content is about 50% by weight. Cured films made by coagulating this dispersion have a 100% modulus of approximately 2 MPa and an elongation of 900-1000%. Coating compositions Examples 1-4 and Comparative Samples A-E are made from the ingredients listed in Table 1 by combining them and mixing them in a high-speed laboratory mixer to produce a homogeneous mixture. Viscosity is measured using a Brookfield apparatus equipped with S64 rotor and operated at 100 rpm. Odor is evaluated subjectively by placing 10 g of the composition into a 50 ml bottle and sealing the bottle under nitrogen. The bottle and its contents are held at 20-23° C. for 24 hours. The bottle is then opened and the odor subjectively determined on a scale of 1-10, with 1 indicating no detectable odor, 5 indicating a noticeable but tolerable odor, and higher values indicating greater odor.

TABLE 1
Top Layer Formulation

| | Parts By Weight | | | | | | | | |
|---|---|---|---|---|---|---|---|---|---|
| Ingredient | A* | B | Ex. 1 | Ex. 2 | Ex. 3 | Ex. 4 | C* | D* | E* |
| Acrylic/PCM | 0 | 10 | 25 | 40 | 50 | 60 | 75 | 90 | 100 |
| Emulsion | | | | | | | | | |
| PU Emulsion | 100 | 90 | 75 | 60 | 50 | 40 | 25 | 10 | 0 |
| Leveling | 1 | 1 | 1 | 1 | 1 | 1 | 1 | 1 | 1 |
| Agent¹ | | | | | | | | | |
| Antifoaming | 0.5 | 0.5 | 0.5 | 0.5 | 0.5 | 0.5 | 0.5 | 0.5 | 0.5 |
| Agent | | | | | | | | | |
| Feel Modifier² | 0.5 | 0.5 | 0.5 | 0.5 | 0.5 | 0.5 | 0.5 | 0.5 | 0.5 |
| Propylene | 5 | 5 | 5 | 5 | 5 | 5 | 5 | 5 | 5 |
| Glycol | | | | | | | | | |
| Aridine | 1 | 1 | 1 | 1 | 1 | 1 | 1 | 1 | 1 |
| Crosslinking | | | | | | | | | |
| Agent³ | | | | | | | | | |
| Rheology | 0.3 | 0.3 | 0.3 | 0.3 | 0.3 | 0.3 | 0.3 | 0.3 | 0.3 |
| Modifier⁴ | | | | | | | | | |
| Acrylic | 0 | 2.9 | 7.4 | 11.8 | 14.8 | 17.7 | 22.2 | 26.6 | 29.5 |
| Elastomer | | | | | | | | | |
| Solids, % | | | | | | | | | |
| (approx.) | | | | | | | | | |
| PU Elastomer | 46.2 | 41.6 | 34.6 | 27.7 | 23.0 | 18.5 | 11.5 | 4.6 | 0 |
| Solids, % | | | | | | | | | |
| (approx.) | | | | | | | | | |
| Encapsulated | 0 | 2.1 | 5.3 | 8.5 | 10.6 | 12.7 | 15.9 | 19.1 | 21.2 |
| PCM, % | | | | | | | | | |
| (approx.) | | | | | | | | | |
| Total | 49.6 | 49.8 | 50.9 | 51.8 | 52.2 | 52.7 | 53.5 | 54.2 | 54.6 |
| Solids, % | | | | | | | | | |
| Odor | 1 | 1 | 1 | 1 | 1 | 2 | 2 | 3 | 5 |
| Viscosity, cps | 1698 | 1878 | 1944 | 1830 | 1746 | 1584 | 1542 | 1530 | 1560 |
| @25° C. | | | | | | | | | |

*Not an example of the invention.
¹BYK 346 from BYK USA Inc.
²ROSILK ™ silicone emulsion from The Dow Chemical Company.
³ZS-100, from Guangzhou Zengmao Chemical Technology Co., Ltd.
⁴Acrysol ™ RM-825, from The Dow Chemical Company.

Preparation and Testing of Test Films. To make films for physical property testing, 5-gram samples of the coating compositions are spread onto glass plates with an anti-adhesion coating, and dried overnight at 20-23° C. The film is then removed from the glass and further cured for 2 hours in a 60° C. oven. Specimens are cooled to 20-23° C. for further testing. Tensile strength, elongation and modulus are measured according to GB/T 528-2009.

Larger films are made for evaluation of thermal properties by pouring the coating compositions onto release paper to produce a 2 mm-thick coating, drying the film overnight at 20-23° C., removing the film from the release paper and further curing it at 80° C. for 2 hours. Cooling effect is measured according to GB/T 36263-2017, and subjectively by bringing the film to a temperature of 20-23° C. and applying a hand to the film and rating the cooling sensation on a scale of 1-5, with a 1 rating indicating no discernable cooling effect and 5 indicating a strong cooling effect.

Results from these evaluations and the approximate composition of the cured coatings (as calculated from the composition of the coating composition) are as indicated in Table 2.

TABLE 2
Film Sample Properties

| Cured | | | | | | | | | |
|---|---|---|---|---|---|---|---|---|---|
| Coating | Weight-% | | | | | | | | |
| Component | A* | B* | Ex. 1 | Ex. 2 | Ex. 3 | Ex. 4 | C* | D* | E* |
| Acrylic | 0 | 5.8 | 14.5 | 22.8 | 28.4 | 33.6 | 41.5 | 49.1 | 54.0 |
| Elastomer | | | | | | | | | |
| PU Elastomer | 93 | 83.5 | 68.0 | 53.5 | 44.1 | 35.1 | 21.5 | 8.5 | 0 |
| Encapsulated | 0 | 4.2 | 10.4 | 16.4 | 20.3 | 24.1 | 29.7 | 35.2 | 38.8 |
| PCM | | | | | | | | | |
| Tensile Str, | 24.66 | 19.67 | 15.77 | 10.22 | 8.21 | 6.71 | 4.4 | 1.37 | 0.48 |
| MPa | | | | | | | | | |
| Elongation, % | 818 | 795 | 880 | 851 | 734 | 511 | 329 | 241 | 43 |
| Modulus, | 2.65 | 1.73 | 1.35 | 1.23 | 1.12 | 1.14 | 1.02 | 0.82 | ND |
| MPa | | | | | | | | | |
| GB/T | 0.55 | 0.61 | 0.64 | 0.54 | 0.80 | 0.86 | 0.83 | 1.0 | 0.7 |
| 36263-2017 | | | | | | | | | |
| Cooling | | | | | | | | | |
| Effect, | | | | | | | | | |
| J/cm² · s | | | | | | | | | |
| Hand | 2 | 3 | 3 | 3.5 | 4 | 4 | 4.5 | 5 | 5 |
| Cooling | | | | | | | | | |
| Effect | | | | | | | | | |
| Rating | | | | | | | | | |

*Not an example of the invention.

Three-layer synthetic leathers are prepared from each of the coating compositions. The coating composition is poured out onto release paper and formed into a 100 μm film using a coiled bar. The film is dried at 100° C. for five minutes. A 300 μm layer of a polyurethane foam is applied on top of the dried film and oven dried at 140° C. for 90 seconds. A fabric substrate is applied to the exposed surface of the foam layer, followed by further drying at 120° C. for 3 minutes. The release paper is then removed to expose the skin layer.

The artificial leathers are evaluated for cooling effect according to GB/T 36263-2017, and subjectively rated as described above. High temperature adhesion resistance is determined according to GB/T 8949-2008. Two pieces of each artificial leather are placed skin layer-to-skin layer and clamped between glass sheets with a 5 kg load placed on top. After heating for 2 hours at 50° C., the samples are cooled at room temperature for 30 minutes. The artificial leather pieces are then separated by hand and subjectively evaluated on a 1-5 scale for the difficulty in pulling them apart. A rating of 5 indicates the pieces pull apart with minimal effort; lower numbers reflect greater difficulty with a 1 rating meaning the pieces cannot be pulled apart.

Surface smoothness is evaluated subjectively by folding a piece of the artificial leather sample in half so the skin surfaces of the two halves are in contact. The samples are then rubbed manually to evaluate how easily the skin surfaces move past each other. The samples are rated on a 1-5 scale, with a 5 value indicating highest surface smoothness and a 1 value indicating the skin surfaces do not move past each other when rubbed.

Surface softness is evaluated subjectively by rubbing the skin with fingers and rating the softness on a 1-5 scale, with a 5 rating indicating a very soft surface and a 1 rating indicating a hard surface.

Peel strength of the top layer to the underlying layer is evaluated according to GB/T 8949-2008. Samples 3 cm wide are placed top layer-to-top layer with a layer of a cyanoacrylate glue layer between. The cyanoacrylate glue layer is cured by drying at 135° C. for 2 hours. The samples are cooled to room temperature. Two ends of the bonded sample are separated and peeled apart at a speed of 500 mm/minute while measuring the average load in N/3 cm.

I A frost test is performed by cutting the sample into 5 cm×5 cm squares. The squares are immersed in boiling water for 5 minutes, then cooled and dried at room temperature. The samples are inspected visually for the appearance of frost on the skin layer.

Results of these evaluations are also as indicated in Table 3.

TABLE 3
Artificial Leather Properties

| Test | A* | B* | Ex. 1 | Ex. 2 | Ex. 3 | Ex. 4 | C* | D* | E* |
|---|---|---|---|---|---|---|---|---|---|
| GB/T | 0.41 | 0.5 | 0.5 | 0.53 | 0.56 | 0.5 | 0.54 | 0.6 | 0.6 |
| 36263-2017 | | | | | | | | | |
| Cooling | | | | | | | | | |
| Effect, | | | | | | | | | |
| J/cm² · s | | | | | | | | | |
| Hand touch | 2 | 2 | 3 | 3.5 | 4 | 4 | 4 | 4.5 | 4.5 |
| coolness | | | | | | | | | |
| rating | | | | | | | | | |
| High | 4 | 4.5 | 4.5 | 5 | 5 | 5 | 4.5 | 4 | 4 |
| temperature | | | | | | | | | |
| adhesion | | | | | | | | | |
| resistance | | | | | | | | | |
| Surface | 4 | 4.5 | 5 | 5 | 5 | 5 | 4.5 | 4 | 3 |
| smoothness | | | | | | | | | |
| rating | | | | | | | | | |
| Surface | 3 | 4 | 4.5 | 5 | 5 | 5 | 4 | 4 | 3 |
| softness | | | | | | | | | |
| rating | | | | | | | | | |
| Peel | 40.13 | 39.96 | 34.18 | 24.02 | 22.36 | 14.04 | 9.52 | 4.7 | 4.44 |
| strength, | | | | | | | | | |
| N/3 cm | | | | | | | | | |
| Frost test | N | N | N | N | N | N | N | N | N |
| (Y/N) | | | | | | | | | |

*Not an example of the invention.

Three-layer microfiber artificial leather samples are made as follows. A fabric made with polyamine/polyethylene islands-in-the-sea fibers is impregnated with an externally stabilized polyurethane dispersion (Syntegra® YF-4000) that contains both a cationic and an anionic surfactant, and then cured by drying in an oven. The thus-coated fabric is then immersed in toluene to dissolve the polyethylene filaments and leach them from the fabric, producing a polyurethane-impregnated microfabric base layer.

The coating compositions described before are applied to release paper and formed into 100 μm films using a coil bar. The films are dried at 100° C. for 5 minutes. A 100 μm layer of the same polyurethane dispersion (Syntegra® YF-4000) used to impregnate the fabric is then applied to the dried films and dried at 140° C. for 90 seconds to form an adhesive layer. The polyurethane-impregnated base layer is then applied to the surface of the adhesive layer and the assembly further cured at 120° C. for 5 minutes. The release paper is then removed to expose the skin layer.

Surface smoothness, surface softness, hand touch coolness and peel strength are evaluated as described before. Abrasion resistance is evaluated on 38-mm disk using Martindale Abrasion test equipment at an applied pressure of 12 KPa for 20,000 cycles. A “pass” rating indicates the skin layer remains unbroken. Flex resistance is measured according to GB/T 8949-2008 on 7.5 cm×4.5 cm test specimens. Testing is performed at 20-23° C. at a rate of 100/minute for 100,000 cycles. A “pass” rating indicates the skin layer remains unbroken. Results are as indicated in Table 4.

TABLE 4
Microfiber Artificial Leather Properties

| Test | A* | B* | Ex. 1 | Ex. 2 | Ex. 3 | Ex. 4 | C* | D* | E* |
|---|---|---|---|---|---|---|---|---|---|
| Hand touch | 2 | 2 | 3 | 3.5 | 4 | 4 | 4 | 4.5 | 4.5 |
| coolness | | | | | | | | | |
| rating | | | | | | | | | |
| Surface | 4 | 4.5 | 5 | 5 | 5 | 5 | 4.5 | 4 | 3 |
| smoothness | | | | | | | | | |
| rating | | | | | | | | | |
| Surface | 3 | 4 | 4.5 | 5 | 5 | 5 | 4 | 4 | 3 |
| softness | | | | | | | | | |
| rating | | | | | | | | | |
| Peel | 78.51 | 72.38 | 27.33 | 24.45 | 22.36 | 20.04 | 11.5 | 4.81 | 4.44 |
| strength, | | | | | | | | | |
| N/3 cm | | | | | | | | | |
| Abrasion | Pass | Pass | Pass | Pass | Pass | Pass | Fail | Fail | Fail |
| Test, P/F | | | | | | | | | |
| Flex | Pass | Pass | Pass | Pass | Pass | Pass | Fail | Fail | Fail |
| resistance | | | | | | | | | |
| test, P/F | | | | | | | | | |

As the data in Tables 1 to 4 show, the coating compositions and artificial leathers of the invention offer a unique and desirable combination of properties. The coating composition (Comp. E*) containing the acrylate dispersion by itself has a distinctly noticeable odor. Coating compositions of the invention, by contrast, are odor-free despite the presence of significant amounts of the acrylate dispersion in each of them. Stand-alone films made from coating compositions 1-4 have desirable elongation and modulus properties. The top layers of Examples 1-4 provide a significant “cool touch” effect in the stand alone films (Table 2), and both types of artificial leather (Tables 3 and 4). The artificial leathers of the invention have excellent surface smoothness and surface softness. The artificial leathers of the invention have adequate or better abrasion resistance and flex resistance. Good adhesion between the top layer and the underlying layers is seen in the artificial leathers made using coating compositions 1-4, as evidenced by the peel strength test.

1. An artificial leather comprising a backing layer and a top layer bonded directly or indirectly to the backing layer, the top layer comprising, by total weight of the top layer:
(i) 25 to 75 weight percent of a solid, water-insoluble polyurethane elastomer;
(ii) 10 to 40 weight percent of a solid, water-insoluble acrylate elastomer; and
(iii) 1.5 to 30 weight percent of embedded particles of an encapsulated phase change material that has a melting or glass transition temperature of 20 to 37° C.

2. The artificial leather of claim 1, wherein the combined weight of components (i), (ii), and (iii) constitutes at least 85 weight percent of the total weight of the top layer.

3. The artificial leather of claim 1, further comprising at least one polyurethane foam layer between the backing layer and the top layer.

4. The artificial leather of claim 1, further comprising a barrier layer between the backing layer and the top layer, the barrier layer comprising a cured elastomeric polyurethane coating produced by:
forming a film of an externally stabilized aqueous dispersion comprising a continuous aqueous phase having externally stabilized solid particles of elastomeric polyurethane dispersed therein; and
curing the film.

5. The artificial leather of claim 4, wherein the externally stabilized aqueous dispersion comprises both an anionic surfactant and a cationic surfactant.

6. The artificial leather of claim 1, wherein the backing layer comprises a fabric.

7. The artificial leather of claim 6, wherein the fabric comprises microfibers embedded in a polyurethane binder.

8. The artificial leather of claim 7, wherein the fabric is made by:
i) providing a fabric having islands-in-the-sea fibers having at least two different filament types;
ii) embedding the fabric in a polyurethane binder to form an embedded fabric;
iii) contacting the embedded fabric with a solvent for at least one but less than all of the different filament types of the islands-in-the-sea fibers to dissolve at least one but less than all of the different filament types; and
iv) removing the dissolved filaments from the embedded fabric.

9. The artificial leather of claim 1, wherein the top layer is produced by:
forming a film of an aqueous dispersion comprising a continuous aqueous phase having dispersed therein (i) internally stabilized solid particles of the water-insoluble polyurethane elastomer, (ii) particles of the water-insoluble acrylic elastomer, and (iii) the particles of the encapsulated phase change material; and
curing the film to produce the top layer.

10. An aqueous dispersion comprising a continuous aqueous phase, the continuous aqueous phase having dispersed therein, by total weight of the aqueous dispersion;
(i) 15 to 40 weight percent of internally stabilized solid particles of a water-insoluble polyurethane elastomer;
(ii) 5 to 20 weight percent of particles of a water-insoluble acrylate elastomer; and
(iii) 3 to 15 weight percent of particles of an encapsulated phase change material that has a melting or glass transition temperature of 20 to 37° C.;
with components (i), (ii), and (iii) together constituting 35 to 65% of the total weight of the aqueous dispersion.
